(19) United States
(12) Patent Application Publication
(10) Pub. No.: US 2025/0264732 A1
(43) Pub. Date: Aug. 21, 2025

(54) INTERCHANGEABLE EYEGLASSES DEVICE

(71) Applicant: Herman Humphreys, Grand Rapids, MI (US)

(72) Inventor: Herman Humphreys, Grand Rapids, MI (US)

(21) Appl. No.: 19/014,865

(22) Filed: Jan. 9, 2025

Related U.S. Application Data
(60) Provisional application No. 63/630,627, filed on Feb. 20, 2024.

(51) Int. Cl. G02C 3/00; G02C 7/02

(52) U.S. Cl. CPC G02C 3/003; G02C 7/02

(57) ABSTRACT

An interchangeable eyeglasses device includes a pair of eyeglasses which has a pair of temples and a pair of rims and a bridge. Each rim has an entrance extending between the bridge and a respective temple of the pair of temples. A pair of lenses is each insertable through the entrance in a respective rim to seat each of the pair of lenses in the respective rim. A pair of arms is each pivotally coupled to the pair of eyeglasses. Each arm is positionable in a closed position has each arm extending across the entrance in a respective one of the pair of rims for retaining the pair of lenses in the pair of rims. Conversely, each arm is positionable in an open position for removing the pair of lenses from the pair of rims.

### CROSS-REFERENCE TO RELATED APPLICATIONS

I hereby claim the benefit under 35 U.S.C. Section 119(e) of U.S. Provisional application 63/630,627 filed on Feb. 20, 2024

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to eyeglasses devices and more particularly pertains to a new eyeglasses device for removing and/or replacing lenses in rims of a pair of eyeglasses. The device includes a pair of eyeglasses that has a pair of rims which each has an entrance and a pair of lenses that can each be inserted through the entrance in a respective rim. The device includes a pair of arms each pivotally attached to the pair of eyeglasses which extend across the entrance in a respective rim when the arms are in a closed position to retain the lenses in the rims. The device includes a pair of first magnets which are integrated into a respective rim and a pair of second magnets which are integrated into a respective arm. Each second magnet magnetically engages a respective first magnet when a respective arm is in the closed position to retain the respective arm in the closed position.

### (2) Description of Related Art Including Information Disclosed under 37 CFR 1.97 and 1.98

The prior art relates to eyeglasses devices including: an interchangeable lens system that includes a curved safety lens and a support member which clips onto the curved safety lens; an interchangeable eyeglass device which includes a pair of lenses integrated into a frame and an eyeglasses frame that insertably receives the frame of the lenses; an eyeglass lens rim and frame system which includes a pair of lenses that are integrated into a frame and an eyeglasses frame that insertably receives the frame of the lenses and a pair of first magnets integrated into the frame of the lenses that magnetically engage a pair of second magnets which are integrated into the frame of the eyeglasses; an interchangeable eyeglass lens system that includes an eyeglasses frame that has a pair of rims and a slot extending through each rim which insertably receives a lens to position the lens in a respective rim; an interchangeable eyeglass lens system that includes an eyeglasses frame and a bridge coupler that is attachable to the eyeglasses frame via a pair of magnets and a lens that is attachable to the eyeglasses frame and the bridge coupler with a pair of screws. In no instance does the prior art disclose an interchangeable eyeglasses device that includes a pair of eyeglasses that includes a pair of rims which each has an entrance through which a lens can be inserted and a pair of arms which are each pivotally attached to the eyeglasses which extend across the entrance in a respective rim and a pair of first magnets integrated into the eyeglasses and a pair of second magnets each integrated into a respective arm which magnetically engage a respective first magnet to retain the pair of arms in a closed position.

### BRIEF SUMMARY OF THE INVENTION

An embodiment of the disclosure meets the needs presented above by generally comprising a pair of eyeglasses which has a pair of temples and a pair of rims and a bridge. Each rim has an entrance extending between the bridge and a respective temple of the pair of temples. A pair of lenses is each insertable through the entrance in a respective rim to seat each of the pair of lenses in the respective rim. A pair of arms is each pivotally coupled to the pair of eyeglasses. Each arm is positionable in a closed position has each arm extending across the entrance in a respective one of the pair of rims for retaining the pair of lenses in the pair of rims. Conversely, each arm is positionable in an open position for removing the pair of lenses from the pair of rims.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an interchangeable eyeglasses device according to an embodiment of the disclosure.

FIG. 2 is a perspective view of an embodiment of the disclosure showing a pair of arms in an open position.

FIG. 3 is a front view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

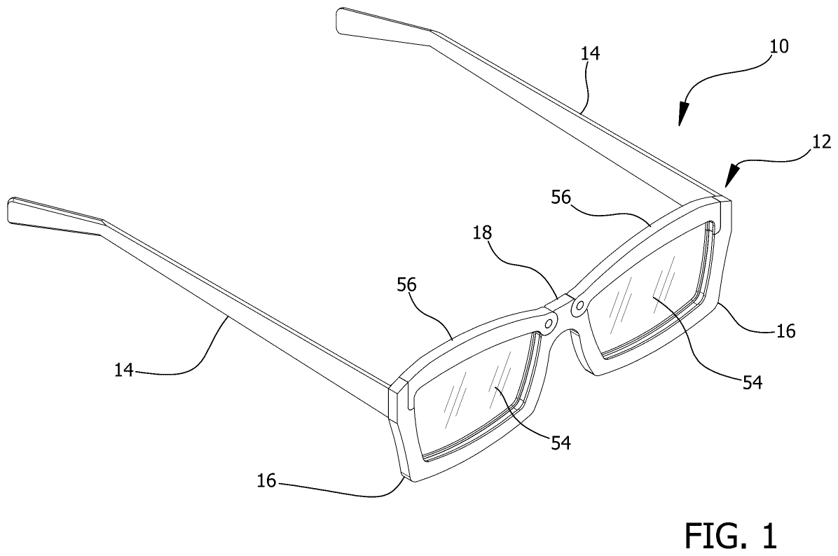

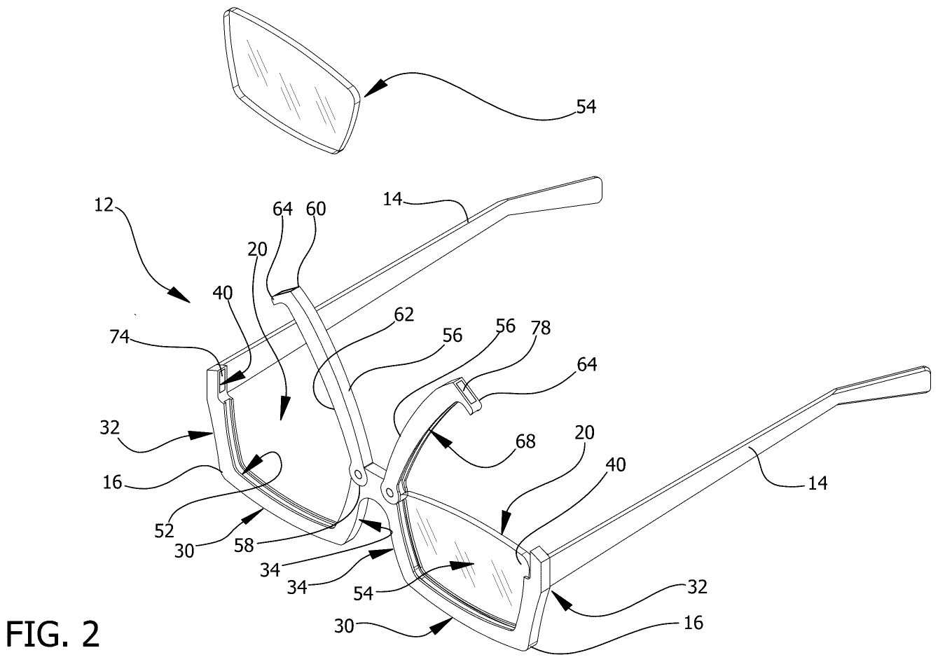

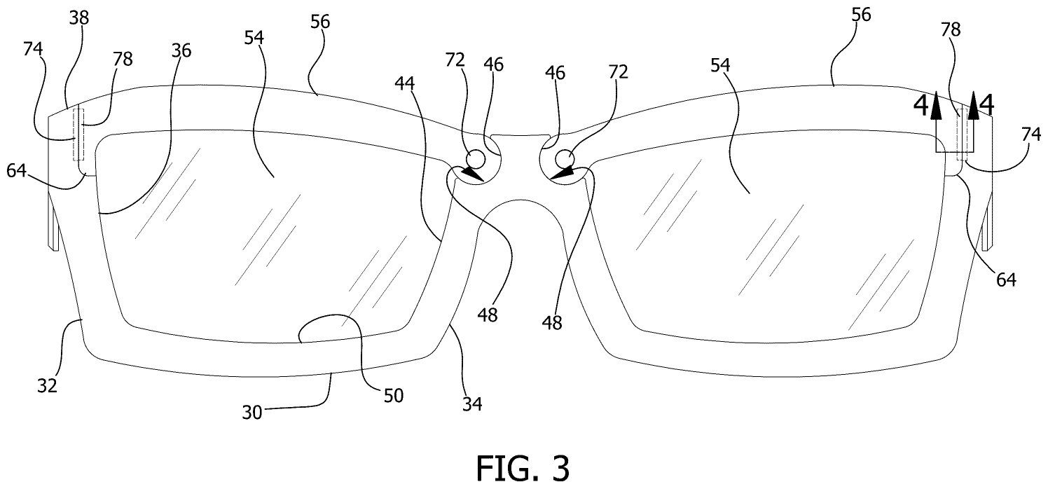

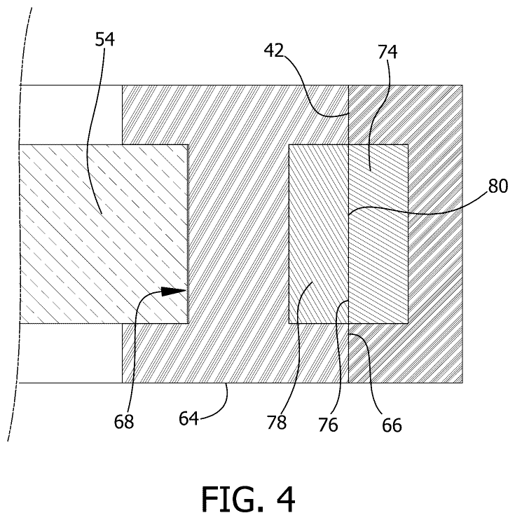

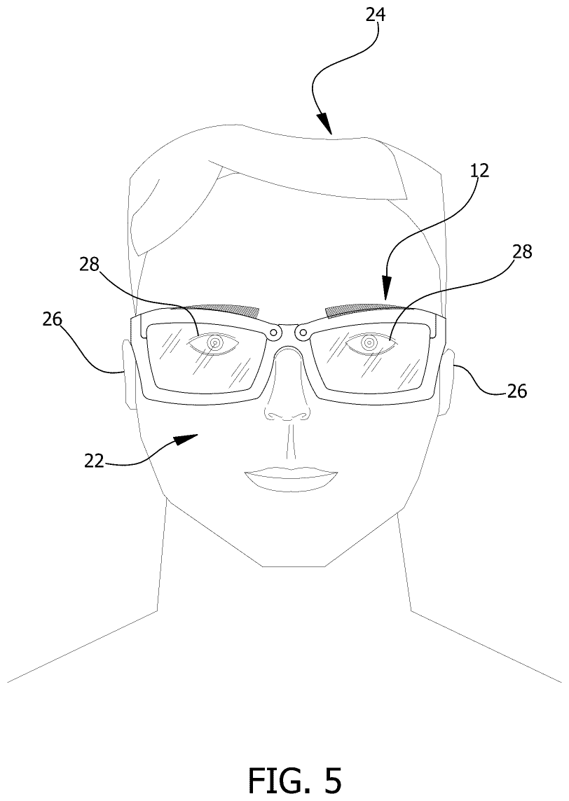

With reference now to the drawings, and in particular to FIGS. 1 through 5 thereof, a new eyeglasses device embodying the principles and concepts of an embodiment of the disclosure and generally designated by the reference numeral 10 will be described.

As best illustrated in FIGS. 1 through 5, the interchangeable eyeglasses device 10 generally comprises a pair of eyeglasses 12 which includes a pair of temples 14 and a pair of rims 16 and a bridge 18. Each rim 16 of the pair of rims 16 has an entrance 20 extending between the bridge 18 and a respective temple 14 of the pair of temples 14. Additionally, each temple 14 of the pair of temples 14 is hingedly coupled to a respective rim 16 of the pair of rims 16 such that the pair of eyeglasses 12 can be worn on a face 22 of a user 24 having the pair of temples 14 extending over a respective ear 26 of the user 24 and having the pair of rims 16 being located around a respective eye 28 of the user 24. Each rim 16 of the pair of rims 16 has a bottom member 30 extending between each of a first sidelong member 32 and a second sidelong member 34 such that each rim 16 of the pair of rims 16 has a U-shape. Furthermore, the entrance 20 of a respective rim 16 is defined between the first sidelong member 32 and the second sidelong member 34 of the respective rim 16 and the bridge 18 extends between the second sidelong member 34 of each rim 16 of the pair of rims 16.

The first sidelong member 32 of each rim 16 of the pair of rims 16 has an inwardly facing surface 36 and a top end 38. Additionally, the first sidelong member 32 of each rim 16 of the pair of rims 16 has a notch 40 which is recessed into the inwardly facing surface 36. The notch 40 in the first sidelong member 32 extends from the top end 38 of the first sidelong member 32 toward the bottom member 30 and the notch 40 has a lateral bounding surface 42. The second sidelong member 34 of each rim 16 of the pair of rims 16 has an inwardly facing surface 44 which is directed toward the inwardly facing surface 36 of the first sidelong member 32 of a respective rim 16.

The pair of eyeglasses 12 has a pair of recesses 46 which is each recessed into an intersection between the bridge 18 and the inwardly facing surface 44 of the second sidelong member 34 of a respective rim 16 of the pair of rims 16. Each recess 46 of the pair of recesses 46 has a bounding surface 48 which is concavely arcuate with respect to the inwardly facing surface 44 of the second sidelong member 34 of the respective rim 16. The bottom member 30 of each rim 16 of the pair of rims 16 has an upwardly facing surface 50 and each rim 16 of the pair of rims 16 has a groove 52 extending into the inwardly facing surface 36 of the first sidelong member 32 and the upwardly facing surface 50 of the bottom member 30 and the inwardly facing surface 44 of the second sidelong member 34.

A pair of lenses 54 is provided and each lens 54 of the pair of lenses 54 is insertable through the entrance 20 in a respective rim 16 of the pair of rims 16 to seat each of the pair of lenses 54 in the respective rim 16. A respective lens 54 of the pair of lenses 54 is fitted into the groove 52 in the respective rim 16 when the respective lens 54 is seated into the respective rim 16. Each lens 54 of the pair of lenses 54 may be prescription lenses to correct the vision of the user 24 or tinted lenses to protect the eyes 28 of the user 24 from sunlight or any other conventional type of eyeglass lens.

A pair of arms 56 is provided and each arm 56 of the pair of arms 56 is pivotally coupled to the pair of eyeglasses 12. Each arm 56 of the pair of arms 56 is positionable in a closed position having each arm 56 of the pair of arms 56 extending across the entrance 20 in a respective rim 16 of the pair of rims 16 for retaining the pair of lenses 54 in the pair of rims 16. Conversely, each arm 56 of the pair of arms 56 is positionable in an open position having each arm 56 of the pair of arms 56 being displaced from the entrance 20 in the respective rim 16 for removing the pair of lenses 54 from the pair of rims 16. Each arm 56 of the pair of arms 56 has a first end 58 and a second end 60 and a lower surface 62 extending between the first end 58 and the second end 60; the first end 58 of each arm 56 of the pair of arms 56 is rounded. Each arm 56 of the pair of arms 56 has a finger 64 extending downwardly from the lower surface 62 and the finger 64 on a respective arm 56 is aligned with the second end 60 of the respective arm 56. Additionally, the finger 64 on each arm 56 of the pair of arms 56 has an outwardly facing surface 66.

Each arm 56 of the pair of arms 56 has a groove 68 which is recessed into the lower surface 62 and which extends between the first end 58 and a distal end 70 of the finger 64. The first end 58 of each arm 56 of the pair of arms 56 is positioned in a respective recess 46 of the pair of recesses 46 in the bridge 18 having the first end 58 of each arm 56 of the pair of arms 56 conforming to the bounding surface 48 of the respective recess 46. Additionally, each arm 56 of the pair of arms 56 has a pivot point 72 located adjacent to the first end 58 which pivotally engages the bridge 18. The finger 64 on a respective arm 56 of the pair of arms 56 extends into the notch 40 in the inwardly facing surface 36 of the first sidelong member 32 of a respective rim 16 of the pair of rims 16 when the respective arm 56 is in the closed position having a respective lens 54 extending into the groove 68 in the respective arm 56.

A pair of first magnets 74 is each recessed into the lateral bounding surface 42 of the notch 40 in the inwardly facing surface 36 of the first sidelong member 32 of a respective rim 16 of the pair of rims 16. Each first magnet 74 of the pair first magnets 74 has an exposed surface 76 which lies flush with the lateral bounding surface 42 of the notch 40. A pair of second magnets 78 is each recessed into the outwardly facing surface 66 of the finger 64 on a respective arm 56 of the pair of arms 56. Each second magnet 78 of the pair of second magnets 78 has an exposed surface 80 which lies flush with the outwardly facing surface 66 of the finger 64 on the respective arm 56. Additionally, the second magnet 78 associated with a respective arm 56 of the pair of arms 56 magnetically engages a respective first magnet 74 of the pair of first magnets 74 when the respective arm 56 is positioned in the closed position for releasably retaining the respective arm 56 in the closed position.

In use, each arm 56 of the pair of arms 56 is positioned in the open position and each lens 54 of the pair of lenses 54 is seated into the groove 52 that is integrated into a respective rim 16 of the pair of rims 16. Each arm 56 of the pair of arms 56 is positioned in the closed position such that each lens 54 of the pair of lenses 54 extends into the groove 68 that is integrated into a respective arm 56 of the pair of arms 56. The pair of lenses 54 is subsequently secured in the pair of rims 16 such that the pair of lenses 54 is oriented to be positioned in front of a respective eye 28 of the user 24 when the user 24 wears the eyeglasses 12. Furthermore, the first magnets 74 and the second magnets 78 retain the pair of arms 56 in the closed position to inhibit the lenses 54 from being accidentally removed from the rims 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present. unless the context clearly requires that there be only one of the elements.

I claim:

1. An interchangeable eyeglasses device comprising:
a pair of eyeglasses, said pair of eyeglasses having a pair of temples and a pair of rims and a bridge, each rim of said pair of rims having an entrance extending between said bridge and a respective temple of said pair of temples, each temple of said pair of temples being hingedly coupled to a respective one of said pair of rims wherein said pair of eyeglasses is configured to be worn on a face of a user having said pair of temples extending over a respective ear of the user and having said pair of rims being located around a respective eye of the user;
a pair of lenses, each lens of said pair of lenses being insertable through said entrance in a respective rim of said pair of rims to seat each of said pair of lenses in said respective rim; and
a pair of arms, each arm of said pair of arms being pivotally coupled to said pair of eyeglasses, each arm of said pair of arms being positionable in a closed position having each arm of said pair of arms extending across said entrance in a respective one of said pair of rims for retaining said pair of lenses in said pair of rims, each arm of said pair of arms being positionable in an open position having each arm of said pair of arms being displaced from said entrance in said respective rim for removing said pair of lenses from said pair of rims.

2. The interchangeable eyeglasses device according to claim 1, wherein each rim of said pair of rims has a bottom member extending between each of a first sidelong member and a second sidelong member such that each rim of said pair of rims has a U-shape having said entrance of a respective rim being defined between said first sidelong member and said second sidelong member of said respective rim.

3. The interchangeable eyeglasses device according to claim 2, wherein:
said first sidelong member of each rim of said pair of rims has an inwardly facing surface and a top end;
said first sidelong member of each rim of said pair of rims has a notch being recessed into said inwardly facing surface;
said notch in said first sidelong member extends from said top end of said first sidelong member toward said bottom member; and
said notch has a lateral bounding surface.

4. The interchangeable eyeglasses device according to claim 3, wherein:
said bridge extends between said second sidelong member of each rim of said pair of rims;
said second sidelong member of each rim of said pair of rims has an inwardly facing surface; and
said pair of eyeglasses has a pair of recesses each being recessed into an intersection between said bridge and said inwardly facing surface of said second sidelong member of a respective one of said pair of rims.

5. The interchangeable eyeglasses device according to claim 4, wherein each recess of said pair of recesses has a bounding surface being concavely arcuate with respect to said inwardly facing surface of said second sidelong member of said respective rim.

6. The interchangeable eyeglasses device according to claim 5, wherein:
each arm of said pair of arms has a first end and a second end and a lower surface extending between said first end and said second end;
said first end of each arm of said pair of arms is rounded; and
said first end of each arm of said pair of arms is positioned in a respective one of said pair of recesses in said bridge having said first end of each arm of said pair of arms conforming to said bounding surface of said respective recess.

7. The interchangeable eyeglasses device according to claim 6, wherein each arm of said pair of arms has a pivot point located adjacent to said first end which pivotally engages said bridge.

8. The interchangeable eyeglasses device according to claim 3, wherein:
each arm of said pair of arms has a first end and a second end and a lower surface extending between said first end and said second end;
each arm of said pair of arms has a finger extending downwardly from said lower surface; and
said finger on a respective arm is aligned with said second end of said respective arm; and
said finger on a respective one of said pair of arms extends into said notch in said inwardly facing surface of said first sidelong member of a respective one of said pair of rims when said respective arm is in said closed position.

10. The interchangeable eyeglasses device according to claim 2, wherein:
said bottom member of each rim of said pair of rims has an upwardly facing surface;
said first sidelong member has an inwardly facing surface;
said second sidelong member has an inwardly facing surface being directed toward said inwardly facing surface of said first sidelong member;
each rim of said pair of rims has a groove extending into said inwardly facing surface of said first sidelong member and said upwardly facing surface of said bottom member and said inwardly facing surface of said second sidelong member;
each arm of said pair of arms has a first end and a second end and a lower surface extending between said first end and said second end;
each arm of said pair of arms has a finger extending downwardly from said lower surface at a point being aligned with said second end;
each arm of said pair of arms has a groove being recessed into said lower surface which extends between said first end and a distal end of said finger;
a respective lens of said pair of lenses is fitted into said groove in said respective rim when said respective lens is seated into said respective rim; and
a respective lens of said pair of lenses extends into said groove in a respective one of said pair of arms when said respective arm is in said closed position.

11. The interchangeable eyeglasses device according to claim 3, wherein:
said interchangeable eyeglasses device includes a pair of first magnets;
each first magnet of said pair of first magnets is recessed into said lateral bounding surface of said notch in said inwardly facing surface of said first sidelong member of a respective rim of said pair of rims; and
each first magnet of said pair first magnets has an exposed surface which lies flush with said lateral bounding surface of said notch.

12. The interchangeable eyeglasses device according to claim 11, wherein:
each arm of said pair of arms includes a finger;
said finger on each arm of said a pair of arms has an outwardly facing surface;
said device includes a pair of second magnets;
each second magnet of said pair of second magnets is recessed into said outwardly facing surface of said finger on a respective arm of said pair of arms; and
each second magnet of said pair of second magnets has an exposed surface which lies flush with said outwardly facing surface of said finger on said respective arm.

13. The interchangeable eyeglasses device according to claim 12, wherein said second magnet associated with a respective arm of said pair of arms magnetically engages a respective first magnet of said pair of first magnets when said respective arm is positioned in said closed position for releasably retaining said respective arm in said closed position.

14. An interchangeable eyeglasses device comprising:
a pair of eyeglasses, said pair of eyeglasses including a pair of temples and a pair of rims and a bridge, each rim of said pair of rims having an entrance extending between said bridge and a respective temple of said pair of temples, each temple of said pair of temples being hingedly coupled to a respective rim of said pair of rims wherein said pair of eyeglasses is configured to be worn on a face of a user having said pair of temples extending over a respective ear of the user and having said pair of rims being located around a respective eye of the user, each rim of said pair of rims having a bottom member extending between each of a first sidelong member and a second sidelong member such that each rim of said pair of rims has a U-shape having said entrance of a respective rim being defined between said first sidelong member and said second sidelong member of said respective rim, said first sidelong member of each rim of said pair of rims having an inwardly facing surface and a top end, said first sidelong member of each rim of said pair of rims having a notch being recessed into said inwardly facing surface, said notch in said first sidelong member extending from said top end of said first sidelong member toward said bottom member, said notch having a lateral bounding surface, said bridge extending between said second sidelong member of each rim of said pair of rims, said second sidelong member of each rim of said pair of rims having an inwardly facing surface being directed toward said inwardly facing surface of said first sidelong member of a respective rim, said pair of eyeglasses having a pair of recesses each being recessed into an intersection between said bridge and said inwardly facing surface of said second sidelong member of a respective rim of said pair of rims, each recess of said pair of recesses having a bounding surface being concavely arcuate with respect to said inwardly facing surface of said second sidelong member of said respective rim, said bottom member of each rim of said pair of rims having an upwardly facing surface, each rim of said pair of rims having a groove extending into said inwardly facing surface of said first sidelong member and said upwardly facing surface of said bottom member and said inwardly facing surface of said second sidelong member;
a pair of lenses, each lens of said pair of lenses being insertable through said entrance in a respective rim of said pair of rims to seat each of said pair of lenses in said respective rim, a respective lens of said pair of lenses being fitted into said groove in said respective rim when said respective lens is seated into said respective rim;
a pair of arms, each arm of said pair of arms being pivotally coupled to said pair of eyeglasses, each arm of said pair of arms being positionable in a closed position having each arm of said pair of arms extending across said entrance in a respective rim of said pair of rims for retaining said pair of lenses in said pair of rims, each arm of said pair of arms being positionable in an open position having each arm of said pair of arms being displaced from said entrance in said respective rim for removing said pair of lenses from said pair of rims, each arm of said pair of arms having a first end and a second end and a lower surface extending between said first end and said second end, said first end of each arm of said pair of arms being rounded, each arm of said pair of arms having a finger extending downwardly from said lower surface, said finger on a respective arm being aligned with said second end of said respective arm, each arm of said pair of arms having a groove being recessed into said lower surface which extends between said first end and a distal end of said finger, said finger on each arm of said pair of arms having an outwardly facing surface, said first end of each arm of said pair of arms being positioned in a respective recess of said pair of recesses in said bridge having said first end of each arm of said pair of arms conforming to said bounding surface of said respective recess, each arm of said pair of arms having a pivot point located adjacent to said first end which pivotally engages said bridge, said finger on a respective arm of said pair of arms extending into said notch in said inwardly facing surface of said first sidelong member of a respective rim of said pair of rims when said respective arm is in said closed position having a respective lens of said pair of lenses extending into said groove in said respective arm;
a pair of first magnets, each first magnet of said pair of first magnets being recessed into said lateral bounding surface of said notch in said inwardly facing surface of said first sidelong member of a respective rim of said pair of rims, each first magnet of said pair first magnets having an exposed surface which lies flush with said lateral bounding surface of said notch; and
a pair of second magnets, each second magnet of said pair of second magnets being recessed into said outwardly facing surface of said finger on a respective arm of said pair of arms, each second magnet of said pair of second magnets having an exposed surface which lies flush with said outwardly facing surface of said finger on said respective arm, said second magnet associated with a respective arm of said pair of arms magnetically engaging a respective first magnet of said pair of first magnets when said respective arm is positioned in said closed position for releasably retaining said respective arm in said closed position.
